(19) United States
(12) Patent Application Publication
(10) Pub. No.: US 2024/0383031 A1
(43) Pub. Date: Nov. 21, 2024

(54) THREAD-ROLLING APPARATUS WITH DISTANCE-SENSING OPERATION

(71) Applicant: CHUAN YI SHENG MACHINERY CO., LTD., KAOHSIUNG CITY (TW)

(72) Inventor: MING-YI HSIAO, KAOHSIUNG CITY (TW)

(21) Appl. No.: 18/650,521

(22) Filed: Apr. 30, 2024

(30) Foreign Application Priority Data
May 16, 2023 (TW) 112118032
Aug. 24, 2023 (TW) 112131920

(51) Int. Cl. B21H 3/04

(52) U.S. Cl. CPC B21H 3/042

(57) ABSTRACT

A thread-rolling apparatus includes a base, a feeding unit, a thread-forming assembly, and a distance-sensing assembly. The base mainly includes a movable portion, a first body, and a second body between the movable portion and the first body. The thread-forming assembly includes cooperating first and second dies and a working passage formed between the dies. The distance-sensing assembly includes at least one sensing unit disposed on the first body and a processing module connected to the sensing unit. The cooperation between the sensing unit and the processing module senses changes in a first distance between the first body and the second body in a non-contact manner whereby abnormal variations can be quickly observed and properly coped, and a second distance of the working passage can be in a normal state. Accordingly, the yield rate of the thread-rolling apparatus can be efficiently increased.

### BACKGROUND OF THE INVENTION

### 1. Field of the Invention

This invention relates to a thread-rolling machine and relates particularly to a thread-rolling apparatus capable of executing a distance-sensing operation.

### 2. Description of the Related Art

Referring to FIG. 1, a conventional thread rolling machine 1 includes a base 11, a feeding unit 12, and a rolling assembly 13 having two rolling dies 131, 132. The base 11 includes two spaced-apart seats, namely a movable seat 111 and a fixed seat 112. The fixed seat 112 includes a main body 112a and an adjusting body 112b. A space between the main body 112a and the adjusting body 112b is adjustable by operating an adjusting member 112c. A passage 133 is formed between the dies 131, 132 downstream of the feeding unit 12. In the process of forming threads, screw blanks are sequentially fed from the feeding unit 12 into the passage 133. Then, each blank is squeezed to form threads thereon while rolling the blank in the passage 133.

Although the dies 131, 132 are located on the base 11 in position, the frequent occurrence of the loosening situation and displacement is still incurred by the high-speed relative movement and vibration between the dies 131, 132 in the long term. Therefore, operators need to subject the rolling assembly 13 to an initial adjustment manually for deciding an initial distance applied to the passage 133 between the two dies 131, 132. Then, an operation of forming threads on screw blanks is based on the initial distance, and screw products are obtained after the forming operation is finished. A manual inspection is also required. The inspection is based on a random selection of the screw products to determine whether the distance of the passage 133 changes and whether the distance needs to be revised. However, a disturbing trend is that multiple machines are synchronously operated because of the machinery automation but are monitored by only one operator. It is difficult for one operator to discover all mistakes immediately and make corrections in a timely manner, which renders the quality of the screw products unable to be efficiently controlled. Therefore, a large number of defective products may be caused, and manufacturing costs may be increased.

Another invention published by Taiwanese Utility Model No. M373788 discloses a pressure detector disposed on a thread-rolling machine and facing a rolling passage between two opposite dies, thereby adjusting the location of the dies according to detected pressure values. The pressure value is derived from the squeezing force added to screw blanks during a thread-forming process. However, this pressure detection mode cannot discover the changes in the distance between the dies immediately if the dies do not loosen explicitly. The conventional invention still needs to be improved.

### SUMMARY OF THE INVENTION

An object of this invention is to provide a thread-rolling apparatus capable of sensing variations in the distance of a fixed portion immediately and adjusting the distance of a working passage in a timely manner according to the variations, thereby allowing the distance of the passage to meet an initial setting condition and increasing the yield rate of a thread-rolling operation.

A thread-rolling apparatus with distance-sensing operation of this invention is as defined in claim 1. The thread-rolling apparatus mainly includes a base, a feeding unit disposed on the base, a thread-forming assembly located downstream of the feeding unit, and a distance-sensing assembly disposed on a fixed portion of the base. The fixed portion includes a first body, a second body, and a first distance defined between the second body and the first body. The second body is located between a movable portion of the base and the first body. The fixed portion is next to the movable portion. The thread-forming assembly includes a first die, a second die, and a working passage between the two dies. A width of the working passage defines a second distance. The distance-sensing assembly includes at least one sensing unit disposed on the first body of the fixed portion and a processing module connected to the sensing unit. A reference value is stored in the processing module. The sensing unit is configured to sense the first distance in a non-contact manner and to generate corresponding numeral data. The processing module subjects the numeral data to immediate comparison, analysis and determination, thereby checking if the first distance changes improperly and deciding if the second distance meets an initial requirement. A timely adjustment to the distances is based on the determination result, thereby preventing improper variations in the second distance during a thread-rolling operation of the thread-rolling apparatus and keeping the value of the second distance initial. Therefore, the quality and the yield rate of the thread-rolling operation can be efficiently increased.

Preferably, the sensing unit includes an emitter and a receiver. The emitter is adapted to emit the signals to the second body. The emitted signals returns back from the second body and then are received by the receiver, thereby allowing the returned signals to undergo the transformation into the numeral data.

Preferably, the distance-sensing assembly includes a plurality of sensing units respectively disposed on the first body.

Preferably, the first body includes a plurality of recesses opposite the second body. Each sensing unit can be disposed in each recess.

Preferably, a space is formed when a width of the first body is lower than a width of the second body. The plurality of sensing units can be respectively disposed in the space.

Preferably, a displaying unit can be connected to the distance-sensing assembly.

Preferably, the signals emitted by the sensing unit can be light signals or wave signals.

### BRIEF DESCRIPTION OF THE DRAWINGS

FIG. 1 is a schematic view showing a conventional thread-rolling machine;

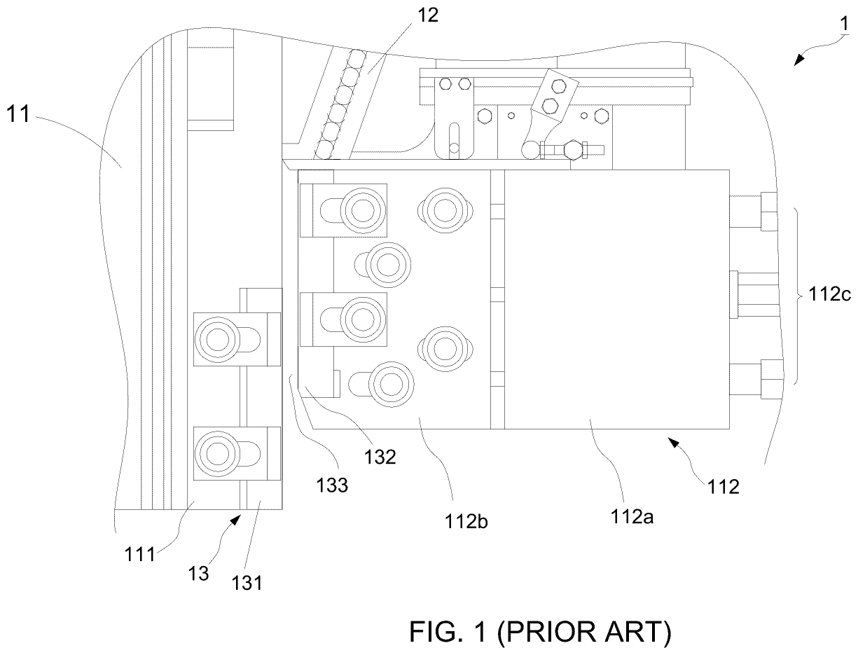

FIG. 2 is a schematic view showing a first preferred embodiment of this invention;

FIG. 3 is a partial schematic view showing the operation of FIG. 2 for conducting an initial setting operation;

FIG. 4 is a partial schematic view showing the operation of FIG. 2 when inappropriate variations in the first distance and the second distance occur;

FIG. 5 is a schematic view showing a second preferred embodiment of this invention;

FIG. 6 is a left-side view of FIG. 5;

FIG. 7 is a schematic view showing the operation of FIG. 5; and

FIG. 8 is a schematic view showing a third preferred embodiment of this invention.

### DETAILED DESCRIPTION OF THE PREFERRED EMBODIMENTS

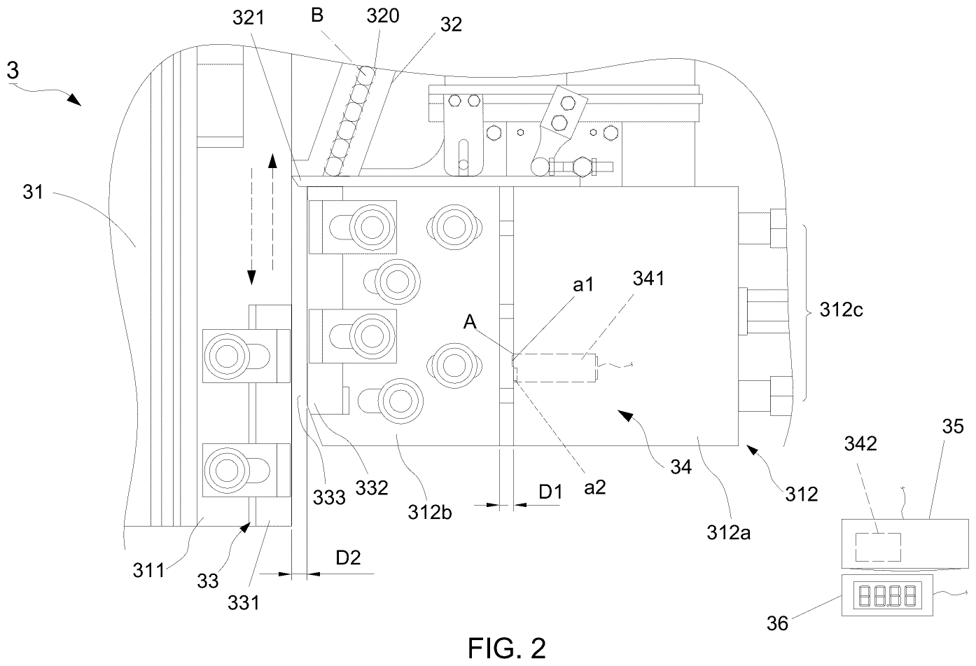

Referring to FIG. 2, a first preferred embodiment of this invention is related to a thread-rolling apparatus 3 with distance-sensing operation. The apparatus 3 includes a base 31 and also includes a feeding unit 32, a thread-forming assembly 33, and a distance sensing assembly 34 respectively disposed on the base 31. The base 31 includes a movable portion 311 and a fixed portion 312 disposed beside the movable portion 311. The fixed portion 312 is spaced apart from the movable portion 311. The fixed portion 312 includes a first body 312a and a second body 312b disposed between the first body 312a and the movable portion 311 and also defines a first distance D1. The first distance D1 is the amount of space between the first body 312a and the second body 312b. An adjusting unit 312c is configured to adjust the first distance D1 between the second body 312b and the first body 312a.

The thread-forming assembly 33 is located downstream of the feeding unit 32 for receiving screw blanks B fed by the feeding unit 32. The thread-forming assembly 33 includes a first die 331 disposed on the movable portion 311, a second die 332 disposed on the second body 312b, and a working passage 333 formed between the first die 331 and the second die 332 and connected to the feeding unit 32. The working passage 333 defines a second distance D2. The second distance D2 is the amount of space based on a width of the working passage 333 between the two dies 331, 332, and the second distance D2 is affected by the first distance D1.

The feeding unit 32 includes a feeding channel 320 where screw blanks B are accommodated and a pushing member 321 disposed between the working passage 333 and the feeding channel 320. The screw blanks B are introduced from the feeding channel 320 towards the first die 331 and pushed to the working passage 333 by the pushing force of the pushing member 321 so that the screw blanks B are sequentially rolled forwards and squeezed between the dies 331, 332 to carry out a thread-rolling operation whereby threads are formed on the blanks B.

The distance-sensing assembly 34 (briefly shown) includes at least one sensing unit 341 and a processing module 342 connected to the sensing unit 341. The sensing unit 341 is disposed on the first body 312a and located relative to the second body 312b. One or more than one sensing unit 341 can be used, and herein one sensing unit 341 is adopted as an example in the first preferred embodiment. The sensing unit 341 has a working end A. Preferably, at the working end A can be disposed an emitter a1 capable of emitting signals and a receiver a2 capable of receiving the signals of the emitter a1. The emitter a1 can be a light emitting device for emitting light signals or a wave emitting device for emitting wave signals. Regarding the emission, the signals can be emitted without interruption or emitted at regular or selected intervals. The signal type and the frequency of the emission of signals can be adjusted according to needs of the thread-rolling operation.

The processing module 342 is connected to the sensing unit 341, and a reference value is stored in the processing module 342. The reference value is the initial basis which is set before a formal thread-rolling operation starts. According to needs, the representation of the reference value can be a designated numeral or a limited numeral range. Referring to FIG. 2, the processing module 342 can be disposed on a control unit 35 of the base 31. Accordingly, the processing module 342 is configured to compare the numeral data transmitted by the sensing unit 341 with the reference value and determine whether the first distance D1 changes, that is, whether there is a variation in the first distance D1. The control unit 35 controls the working state and operations of the base 31 according to the result of the determination. The comparison and determination of the processing module 342 can include following scenarios. One scenario is that when the numeral data corresponds to the reference value, there is no change in the first distance. Another scenario is that when the numeral data falls within the scope of the reference value, the numeral data is still accepted, and therefore there is no improper change in the first distance D1. If the scenarios occur, the processing module 342 does not trigger any operation controlled by the control unit 35. However, a scenario that the numeral data do not correspond to the reference value or do not fall within the scope of the reference value means there is impermissible deviation, that is, an improper change caused by the difference of deviation. In this case, the control unit 35 activates a warning operation according to the determination of the processing module 342 to remind operators. The warning operation can be presented by flashing lights, sounding, stop operating the apparatus, etc. Furthermore, a displaying unit 36 can be connected to the distance-sensing assembly 34, preferably connected to the sensing unit 341. The difference of deviation determined by the processing module 342 can be displayed on the displaying unit 36, and the associated second distance D2 of the working passage 333 can be adjusted according to the displayed difference to overcome the deviation.

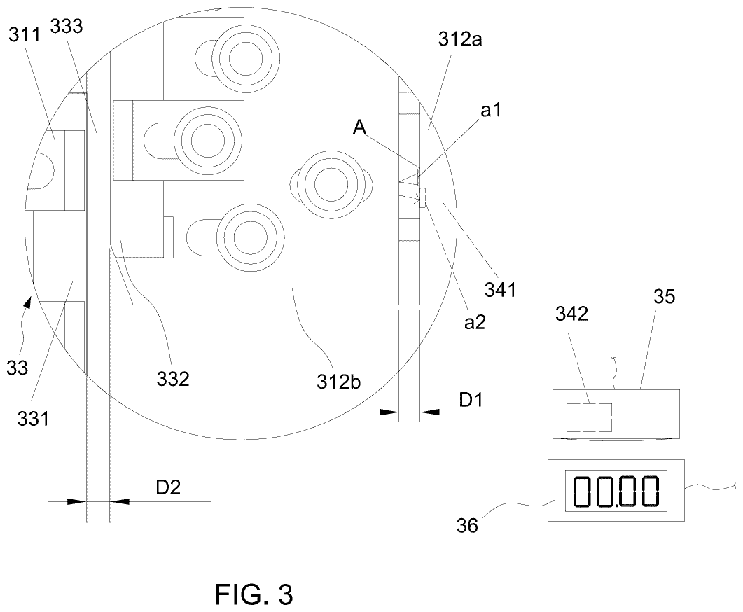

Before conducting a formal thread-rolling operation, an initial setting operation is required and described with the aid of FIG. 2 and FIG. 3. The initial setting operation includes positioning the first die 331 and the second die 332 onto the movable portion 311 and the second body 312b respectively, adjusting and deciding initial locations of the movable portion 311 and the second body 312b respectively to make sure that the first die 331 is parallel to the second die 332 and that the working passage 333 is properly formed therebetween, and then introducing some screw blanks from the feeding unit 32 into the working passage 33 for initial testing. If threads are successfully formed on the tested blanks by rolling the blanks within the passage 333, initial locations of the movable portion 311 and the second body 312b which contribute to the successful initial testing are deemed to be initial basis. Then, the sensing unit 341 disposed on the first body 312a is actuated, so the emitter a1 emits a signal towards the second body 312b for conducting an initial sensing operation. When the emitted signal reaches the second body 312b, it bends back so that the emitted signal returns back to the first body 312a and is received by the receiver a2. The receiver a2 transforms the received signal into numeral data and transmits the numeral data to the processing module 342. According to the numeral data derived from the initial sensing operation, a reference value is set by the processing module 342 and stored in the processing module 342. The representation of the reference value is not limited. As for example shown in FIG. 3, the reference value is a return-to-zero representation as basis of comparison and determination of variations in the distance during a formal thread-rolling operation.

After completing the initial setting operation, it is allowed to start the formal thread-rolling operation, a rolling process for forming threads on the screw blank B. The thread-rolling operation includes guiding screw blanks B from the feeding unit 32 to the pushing member 321 whereby the screw blanks B are sequentially pushed to the working passage 333 and clamped between the dies 331, 332. Then, the operation includes rolling and squeezing the clamped blanks B under the movement of the first die 331 relative to the second die 332, thereby forming threads on each screw blank B. A sensing operation of the sensing unit 341 and the thread-rolling operation work synchronously. That is, when the thread-rolling operation is conducted, the emitter a1 emits signals such as light signals to the second body 312b without stopping. After the emitted signals reach the second body 312b, the signals return back to the first body 312a, that is, the signals are reflected to the first body 312a. Then, the receiver a2 receives the reflected signals and transform related parameters of the signals into numeral data. As an example, the parameter can be the length of the signal. The numeral data is further transmitted to the processing module 342, and the processing module 342 compares the transmitted numeral data with the stored reference value and determines whether to trigger a warning operation.

During the thread-rolling operation, it is common to vibrate the base 31 in a high-speed condition and move the first die 331 quickly via the movable portion 311. The force of rolling and squeezing the screw blank B between the dies 331, 332 is suffered by the second body 312b, and thus the second body 312b becomes loose and deviates from its original location because of the vibration and the rolling and squeezing force. Therefore, the above factors affect the first distance D1 and the second distance D2 related to the first distance D1. Meanwhile, the process module 342 keeps receiving the numeral data transmitted by the receiver a2 while the base 31 works. Each of the numeral data is compared with the reference value. In case the numeral data corresponds to the reference value or in case the numeral data is still within the range of the reference value, the processing module 342 determines that there is no improper variation in the first distance D1 between the second body 312b and the first body 312a. No improper variation in the first distance D1 means the second distance D2 of the working passage 333 is still in a normal state. In this case, the processing module 342 does not trigger the control unit 35, so no warning operation takes action, and the thread-rolling operation keeps working.

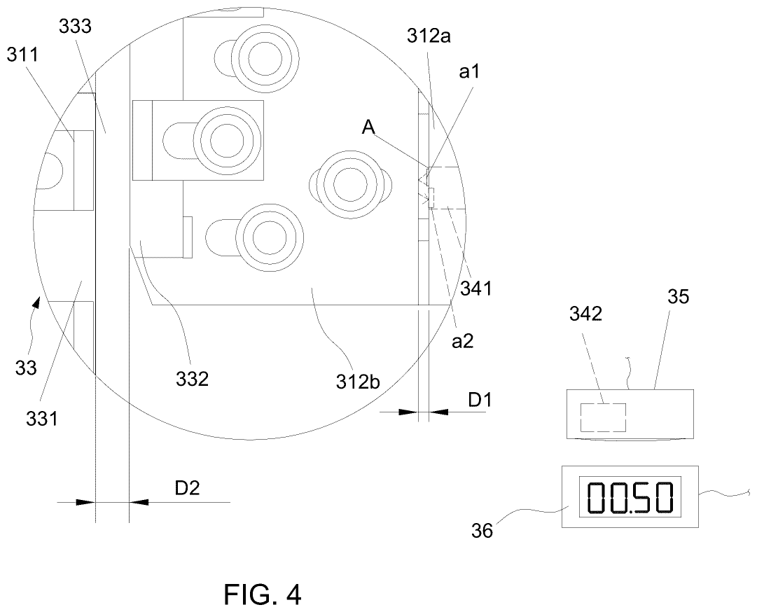

If the received numeral data is higher than or lower than the reference value in terms of a designated value which is set as the reference value for the basis of the comparison, the processing module 342 determines that there is an improper variation or change in the first distance D1. The improper variation means the location of the first distance D1 is in the state of impermissible deviation, and the impermissible deviation leads to improper variation in the second distance D2, that is, the deviation of the distance shown in FIG. 4. Accordingly, the control unit 35 is immediately triggered according to the result of the determination of the processing module 342, which causes a warning device of the base 31 to work for warning and concurrently causes the thread-rolling operation to pause under the control of the control unit 35. Accordingly, an operator can be reminded by the warning device to check and remove faults. A difference value incurred by the improper deviation of the distance can be displayed on the displaying unit 36 (shown in FIG. 4). If necessary, an adjustment to the first distance D1 can be based on the displayed difference value so that the operator operates the adjusting unit 312c to adjust the location of the second body 312b. By the adjustment, the second body 312b returns back to its initial location applied in the initial setting operation, with the result that the second distance D2 is restored to its initial state. After removing the faults or completing the adjustment, the operator can operate the base 31 again to continue the thread-rolling operation.

According to the above operations, the distance-sensing assembly 34 uses the signal transmission to sense changes in the first distance D1 between the second body 312b and the first body 312a, thereby attaining a non-contact detecting and measuring effect. The second distance D2 of the working passage 333 can be quickly adjusted according to the changes in the first distance D1 for correction, thereby increasing the quality of forming threads on screw blanks B and the thread-forming efficiency and also increasing the number of non-defective screw products. In other words, the yield rate of the thread-rolling operation is efficiently increased.

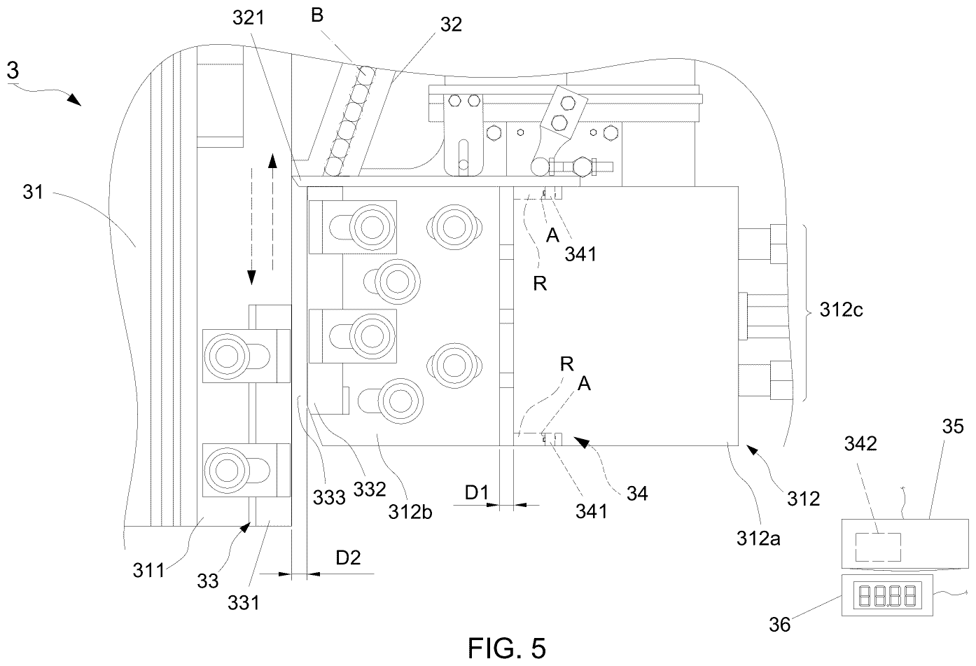

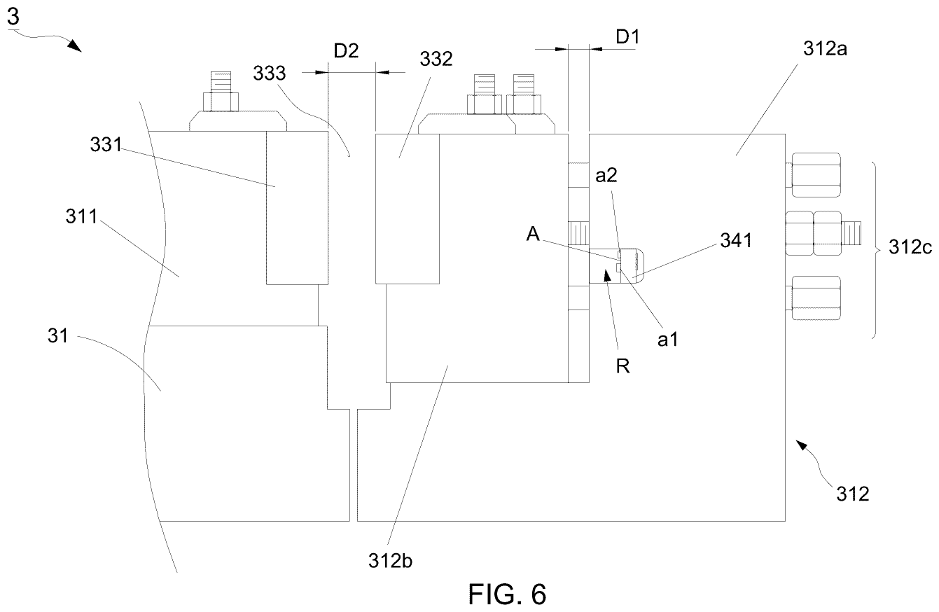

Referring to FIG. 5 and FIG. 6, a second preferred embodiment of this invention includes a base 31, a feeding unit 32, a thread-forming assembly 33, and a distance-sensing assembly 34. The second preferred embodiment is characterized in that the distance-sensing assembly 34 includes a plurality of sensing units 341 respectively disposed on the first body 312a. Herein, the term “a plurality of” means two or more than two sensing units 341. For example, two sensing units 341 are shown in this preferred embodiment, wherein each sensing unit 341 is located on each side of the first body 312a. Furthermore, the first body 312a includes a plurality of recesses R formed thereon. Each sensing unit 341 is disposed in each corresponding recess R and connected to the processing module 342. Preferably, each recess R is opposite the second body 312b. In other words, the recess R faces the second body 312b. Accordingly, in a thread-rolling operation, the processing module 342 compares each numeral data transmitted by each sensing unit 341 with the stored reference value respectively and makes a determination. Alternatively, the processing module 342 conducts a cross comparison between the numeral data of one sensing unit 341 and the numeral data of the other sensing unit 341, compares the result of the cross comparison with the reference value, and thence makes a determination. The mode of comparison can be adjusted according to needs. Further actions associated with the determination result of the second preferred embodiment are the same as those of the first preferred embodiment.

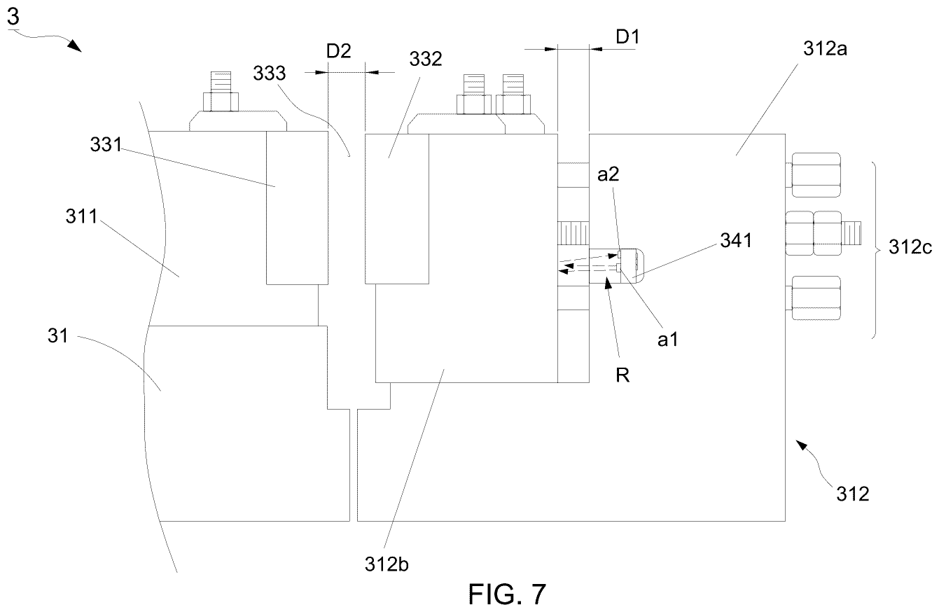

Referring to FIG. 5 and FIG. 7, it is allowed to emit signals from the sensing units 341 to the second body 312b and then reflect the emitted signals back to the recesses R. The use of more than sensing unit 341 can increase the sensitivity and precision of the sensing operation, which is highly beneficial to the detection and measurement of variations in the first distance D1 in a non-contact manner. The numeral data related to the variations can be processed by the processing module 342 so that the working passage 333 can be immediately and properly adjusted or revised when an improper variation or variations occur. Accordingly, the second distance D2 of the passage 333 can maintain its initial state to increase the yield rate of the production.

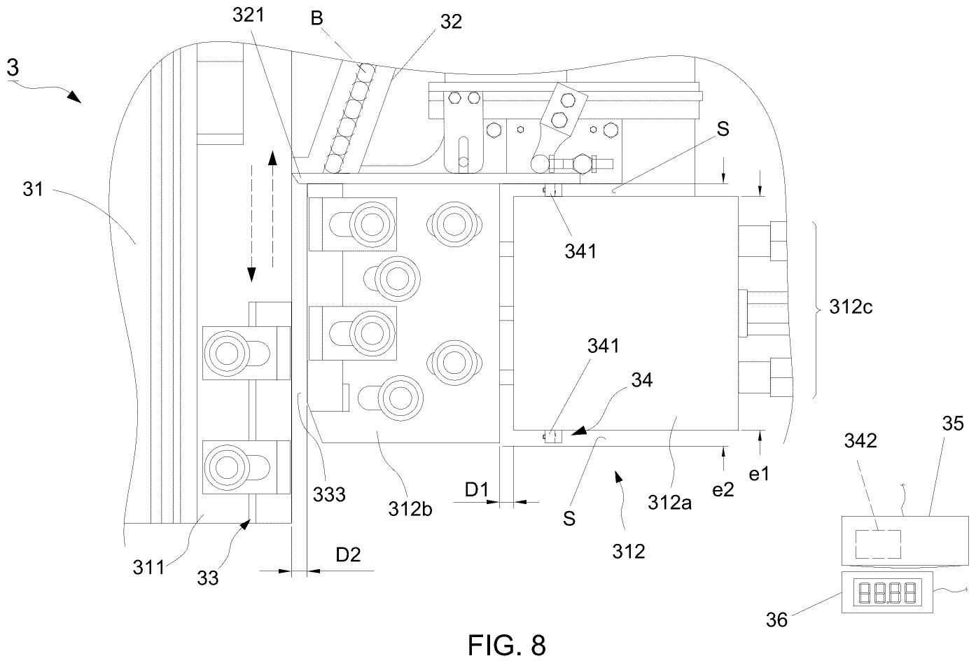

Referring to FIG. 8, a third preferred embodiment of this invention includes the same elements disclosed in the second preferred embodiment. The third preferred embodiment is characterized in that a space S is formed when a width e1 of the first body 312a is lower than a width e2 of the second body 312b, and the sensing units 341 are respectively disposed in the space S. For example, each sensing unit 341 is disposed on one side surface of the first body 312a and faces toward the second body 312b. Accordingly, a non-contact sensing mode conducted by more than one sensing unit 341 still increases the sensitivity and precision of the sensing operation during the thread-rolling operation. The immediate transmission of the numeral data also facilitates the correction and adjustment of the second distance D2 when abnormalities occur, thereby allowing the working passage 333 to maintain its initial state and increasing the yield rate of the thread-rolling operation.

To sum up, this invention takes advantages of the distance-sensing assembly disposed on the fixed portion of the thread-rolling apparatus to sense the first distance between the first body and the second body of the fixed portion in a non-contact manner while forming threads on screw blanks. Numeral data corresponding to each sensed distance can be compared and analyzed, thereby determining whether the second distance of the working passage is abnormal. The second distance can be properly adjusted according to the change in the first distance to ensure that the working passage maintains its initial condition. Thus, the quality and the yield rate of the thread-rolling operation can be efficiently increased.

While the embodiments are shown and described above, it is understood that further variations and modifications may be made without departing from the scope of this invention.

What is claimed is:

1. A thread-rolling apparatus with distance-sensing operation comprising:
a base including a movable portion and a fixed portion disposed beside said movable portion, wherein said fixed portion includes a first body, a second body disposed between said first body and said movable portion, and an adjusting unit configured to adjust a first distance between said second body and said first body;
a feeding unit disposed on said base; and
a thread-forming assembly disposed on said base and located downstream of said feeding unit, wherein said thread-forming assembly includes a first die disposed on said movable portion and a second die disposed on said second body, a working passage being formed between said first die and said second die, a second distance being defined by a width of said working passage and related to said first distance;
wherein a distance-sensing assembly is disposed on said fixed portion, said distance-sensing assembly including at least one sensing unit disposed on said first body and a processing module connected to said sensing unit and having a reference value stored therein, said distance-sensing assembly being configured to emit signals to said second body with said sensing unit, said emitted signals returning back from said second body after said signals reach said second body, said returned signals being received by said sensing unit and transformed into numeral data, said numeral data being transmitted to said processing module for comparison and analysis whereby said sensing unit is adapted to sense variations in said first distance in a non-contact manner during a process of forming threads on screw blanks, thereby determining checking whether said second distance is proper.

2. The apparatus according to claim 1, wherein said sensing unit includes an emitter and a receiver, said emitter being adapted to emit said signals to said second body, said emitted signals returning back from said second body and being received by said receiver and transformed into said numeral data.

3. The apparatus according to claim 1, wherein said distance-sensing assembly includes a plurality of sensing units respectively disposed on said first body.

4. The apparatus according to claim 2, wherein said distance-sensing assembly includes a plurality of sensing units respectively disposed on said first body.

5. The apparatus according to claim 3, wherein said first body includes a plurality of recesses opposite said second body, each of said sensing units being disposed in each of said recesses.

6. The apparatus according to claim 4, wherein said first body includes a plurality of recesses opposite said second body, each of said sensing units being disposed in each of said recesses.

7. The apparatus according to claim 3, wherein a space is formed when a width of said first body is lower than a width of said second body, said sensing units being disposed in said space.

8. The apparatus according to claim 4, wherein a space is formed when a width of said first body is lower than a width of said second body, said sensing units being disposed in said space.

9. The apparatus according to claim 1, further comprising a displaying unit connected to said distance-sensing assembly.

10. The apparatus according to claim 1, wherein said signals emitted by said sensing unit are light signals.

11. The apparatus according to claim 1, wherein said signals emitted by said sensing unit are wave signals.
